(19) United States
(12) Patent Application Publication
(10) Pub. No.: US 2008/0005043 A1
(43) Pub. Date: Jan. 3, 2008

(54) Systems and methods for delivery notification

(76) Inventors: Gary C. Reblin, Falls Church, VA (US); Randall R. Root, Potomac Falls, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/653,270

(22) Filed: Jan. 16, 2007

Related U.S. Application Data
(60) Provisional application No. 60/758,557, filed on Jan. 13, 2006.

(51) Int. Cl. G06F 9/00

(52) U.S. Cl. 705/410

(57) ABSTRACT

Systems and methods for providing notification to box rental users regarding the arrival of mail to their box. In one implementation, the system comprises delivery item processing equipment for sorting and processing the delivery item. The system may also comprise optical equipment associated with the processing equipment for capturing information regarding the delivery item and a server to store the captured information. Further, the system may include a user interface to supply the captured information to the user upon receipt of a user request.

### CROSS-REFERENCE TO RELATED APPLICATION

This Application claims the benefit of U.S. Provisional Application No. 60/758,557, entitled “System and Method for Delivery Notification,” filed Jan. 13, 2006, the disclosure of which is expressly incorporated herein by reference to its entirety.

### TECHNICAL FIELD

The invention relates generally to delivery notification. More specifically, the invention relates to systems and methods for providing notification to users of delivery item rental boxes regarding the delivering of delivery items to the rental box.

### BACKGROUND INFORMATION

The use of rental boxes, such as mailboxes, is common practice in the shipping and delivery item industry. As used herein, a rental box is a secure compartment located at a delivery service provider facility that may be assigned its own address and may be rented by users to receive delivery items in addition to, or in alternate of, a home or business address. These facilities may include the local United States Post Office or stations operated by private companies, such as United Parcel Service, Mail Box etc., and the like. Because each rental box is assigned its own unique mailing address, the user may use this address as a correspondence address. Thus, the rental box is capable of receiving mail and or other delivery items in a similar manner as if a home or business address were used.

Advantages to the use of rental boxes are numerous. For example, a user may use a rental box if the user changes home addresses frequently and needs to establish a permanent place to receive delivery items. Another use of rental boxes is to keep personal or business matters private. That is, a user may direct mail or packages that are of a sensitive nature to a rental box whereby access of others are limited. In addition, a rental box may allow a small business to expand without opening new offices. For instance, a small business is capable of having a local presence in different cities by simply utilizing rental boxes in those cities.

A problem with methods and systems for the current operation of rental boxes is that a user of a box has no way to know what is in their box without physically having to visit the delivery service provider facility where their rental box is located. It would be beneficial to the user of such rental boxes to have a notification of the contents of their boxes so that they may more effectively plan their visits to the delivery service provider facility.

Accordingly, there is a need to provide notification systems and methods to users of rental boxes that would inform the users of the delivering and arrival of mail or packages to their boxes. Such systems and methods may be scalable to allow for the varying of details provided in the notification.

### SUMMARY

In one aspect of the present invention, a method is provided for providing a delivery notification of a delivery item to a user. The method comprises processing the delivery item; capturing information data regarding the delivery item; determining, based on the captured data, the destination of the delivery item; receiving a request from the user for information related to the delivery item; and electronically transmitting a notification to the user regarding information related to the delivery item.

In another aspect of the present invention, a method is provided for providing a delivery notification to a delivery service user. The method comprises receiving an agreement from the user to participate in a notification process; processing an item to be delivered; capturing information data of the item during the processing; delivering the item to a destination address; and supplying the captured data to the user.

In a further aspect of the present invention, a system is provided for providing to a user notification of a delivery item delivered to a rental delivery box. The system comprises delivery item processing equipment for sorting and processing the delivery item; optical equipment associated with the processing equipment for capturing information regarding the delivery item; a server to store the captured information; and a user interface to supply the captured information to the user upon receipt of a user request.

### BRIEF DESCRIPTION OF DRAWINGS

The accompanying drawings, which are incorporated in and constitute a part of this specification, illustrate certain aspects of the present invention and together with the description, serve to explain some of the principles associated with the invention.

FIG. 1 illustrates a block diagram of an exemplary system, consistent with an embodiment of the present invention;

FIG. 2 illustrates an exemplary delivery item sorting process, consistent with an embodiment of the present invention;

FIG. 3 illustrates screen shots of an exemplary user interface, consistent with an embodiment of the present invention; and

FIG. 4 illustrates a flowchart of the notification process, consistent with an embodiment of the present invention;

### DESCRIPTION OF THE EMBODIMENTS

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

### Overview

The implementation of systems and methods to provide notification to rental box users of delivery items delivered to their boxes is described herein through a concept referenced as “Notify.” Although the term “mail” is used in the following description, it is to be understood that the invention is not so limited but rather is applicable to other types of delivery items processed by a delivery service operated by either a private entity or a government.

In one embodiment, Notify operates by allowing Mail Processing Equipment (MPE) to scan and capture data from barcodes, intelligent barcodes, and/or images of mail as they pass through the stages of mail processing, typically at the latter stages of processing. Using the MPE and the information technology infrastructure of the delivery service, the data captured may be sent through the mail processing infrastructure to a Notify application server which may process the data and prepare it to be delivered to a user interface. The user interface may be a “virtual” (i.e., represented through software) box for example, accessed over the internet, that correlates to the physical rental box of a user. Users may access this data and then determine if they need/want to retrieve the mail in their rental box that day. In one level of service, users may receive a notification of delivery, but would not receive any information about the type of mail. At a higher level of service, users may receive additional information describing the specific mix of items delivered to the box, based on code information, such as intelligent bar code information, on the mail. For example, for mail that has a 4-state User Bar Code (4-CB) or an Information Based Indicia (IBI) code, the user may receive an identification of the sender and perhaps even the type of mail (e.g., bill, magazine, 1^{st} class certified, etc.). In yet a higher level of service, a user may receive actual images of the front and/or back of the pieces of mail that will be delivered to their rental boxes for that day.

The Notify concept gives the user flexibility and informed choice. Users may have a variety of options to select from to customize the Notify service to their needs. Implementation and availability of technical capabilities and costs are factors that may affect the possible combinations and levels of service a user would select. In some cases, the user may have the information delivered to them as a mix of the simpler levels, a concise notification of delivery, or a higher level of service that may provide detailed information and/or images. The user may select to have a daily information message sent from the Notify system to their e-mail or a personal Web site at a predetermined time. Further, the user may view their virtual box on-demand or may receive an alert when certain “high value” mail arrives, for example certified mail, other special service mail, or mail likely containing a check, such as IRS tax returns, or mail from specific businesses or services that typically send the user a check. In addition, the Notify system may deliver information about the mail to multiple locations, for example, a user could choose to have information sent to their home and office. If a user is going on travel and they have entrusted someone to accept their mail in the users absence, the user may approve the Notify system to send notifications, such as by e-mail, to another location. In another variation, users on vacation in remote sites may obtain a short-term vacation service enabling them to review images of the mail that the mail deliverer is holding. Other customization features are, of course, available as will be understood by those skilled in the art.

### Exemplary System Architecture

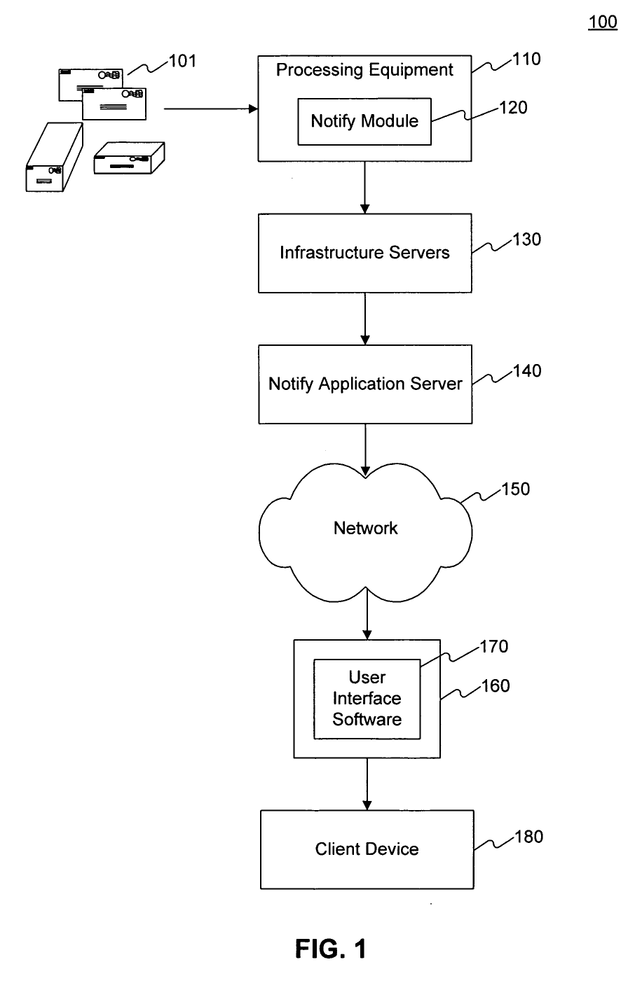

FIG. 1 illustrates a block diagram of an exemplary system 100. As shown, system 100 may include processing equipment 110 used to process mail 101, a Notify module 120, an infrastructure server 130, a Notify application server 140 connected to network 150, and a client device 160. Network 150 may be any wired, wireless, or combination network that is capable of interconnecting Notify application server 140 with client device 160. Client device 160 may allow a user to interact with a user interface software application 170 to receive notifications, for example, regarding the contents of a rental box. Further, although only one client device 160 is illustrated in FIG. 1, network 150 may be capable of connecting multiple client devices to the Notify application server 140.

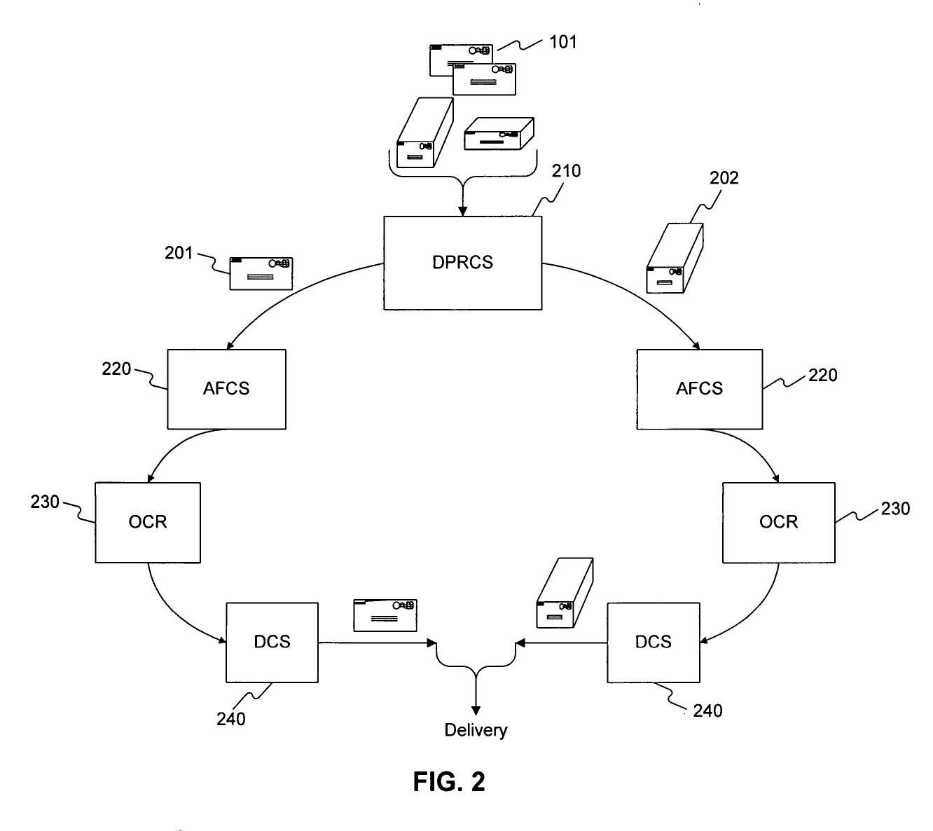

Notify module 120 may comprise scanning equipment and imaging devices used to capture information regarding mail 101 that is being processed. Notify module 120 may be incorporated into the processing equipment 110. Processing equipment 110 may include any device capable of automating the task of processing letters, parcels, and other delivery items. These devices are often modular in nature, thus allowing for the devices to be readily added or replaced. Examples of such devices are illustrated in FIG. 2, which depicts an exemplary mail sorting process.

As illustrated in FIG. 2, the mail sorting process begins by the entry of mail 101 into the mail sorting process. The first piece of sorting equipment may be a Dual Pass Rough Cull System (DPRCS) 210. The DPRCS 210 separates the mail 101 into two streams. The first stream 201, letters (e.g., standard mail envelopes), may be sent to a Advanced Facer-Canceller System (AFCS) 220 which places the separated letters 201 into a single file and standard orientation, checks for appropriate postage, and cancels the postage. Subsequently, the letters 201 may be transferred to a optical character recognition device (OCR) 230. The OCR 230 is capable of reading the address on the letter and converting that address into a code, such as a barcode, which is then printed on the letter 201. It is to be noted that letters already containing coded address information, such as business reply envelopes, may be recognized as such, and will not have another code printed on the envelope. A Delivery Code Sorter (DCS) 240 may then read the coded information and sort the letters 201, for example, by the delivery address of their local destinations. Parcels 202, which were separated by the DPRCS 210, may follow a similar processing path which also ultimately concludes in a final sorting by a DCS 240.

### Exemplary System Operation

The Notify system may comprise imagers that already exist, or additional imagers added to the DCS 240 to capture images and generate image data of mail 101. The image data of mail 101, the address information captured by the OCR device 230, and any other data captured during the sorting process may be transmitted to, processed, and stored by the infrastructure servers 130 (FIG. 1). As used herein, imagers and OCR devices (e.g., OCR device 230) are referred to collectively as “optical equipment.” Subsequently, the image data and address information captured by the optical equipment may be transferred and stored on the Notify application server 140. The Notify application server 140 also stores user information for those users that have chosen to subscribe to the Notify system. The Notify system allows the pertinent image data and address information to be matched to the correct subscribing user and transfers notification information to client device 160 by means of network 150. The notification information transfer may be triggered at either the time the mail is delivered, for example, at the rental box or at some time prior to delivery.

As illustrated in FIG. 1, the Notify system may further comprise a user interface software application 170 that is capable of being run on client device 160. Client device 160 may be a personal computer, a laptop or notebook computer, a personal digital assistant (PDA), a cellular telephone, or the like. User interface software application 170 may be a stand-alone application, a Web browser that may access a specific Web site, or other appropriate type of software application.

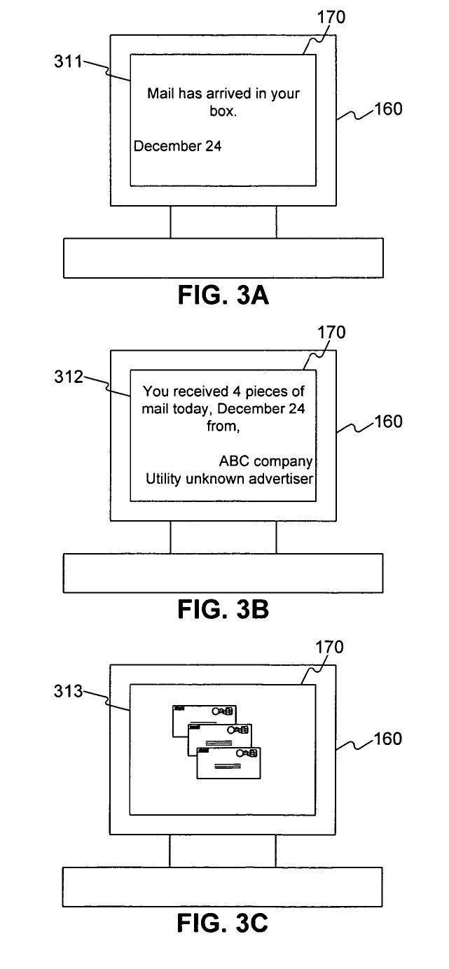

For illustrative purposes, graphical representations of screens or “screen shots,” 311-313 displayed to a user by the user interface software application 170 are depicted in FIGS. 3A-C. The screen shots 311-313 are exemplary variations of views that may be made available to a user based upon their level of subscription to the Notify service.

FIG. 3A illustrates an exemplary screen shot 311 that may be available to a user that has subscribed to a low-level of the Notify service. With this exemplary low-level subscription, a user may receive only a simple notification that mail has arrived, or will arrive in their rental box, and the date of arrival. FIG. 3B illustrates an exemplary screen shot 312 that may be available to a user having a mid-level subscription. In this exemplary screen shot 312, the Notify system provides, through the use of the OCR data, additional information to the user, such as information pertaining to the sender of the mail delivered, or to be delivered, to the user's rental box. FIG. 3C illustrates an exemplary screen shot 313 that may be available to a user having a high-level subscription. As a result of the high-level subscription, the user may be provided with actual images of the pieces of mail 101 captured during the mail processing along with other information, such as expected delivery date. It is to be understood that the number of subscription levels and the data provided to each level is exemplary only. The number of levels may be changed along with data or the combination of data that is provided to each level.

As noted above, the user interface software application 170 may comprise or cooperate with an external Web site maintained by the mail deliverer. In this instance, a user may log on to the Web site to retrieve the notification data. In yet another embodiment, the notification data may be provided to a user through an e-mail system.

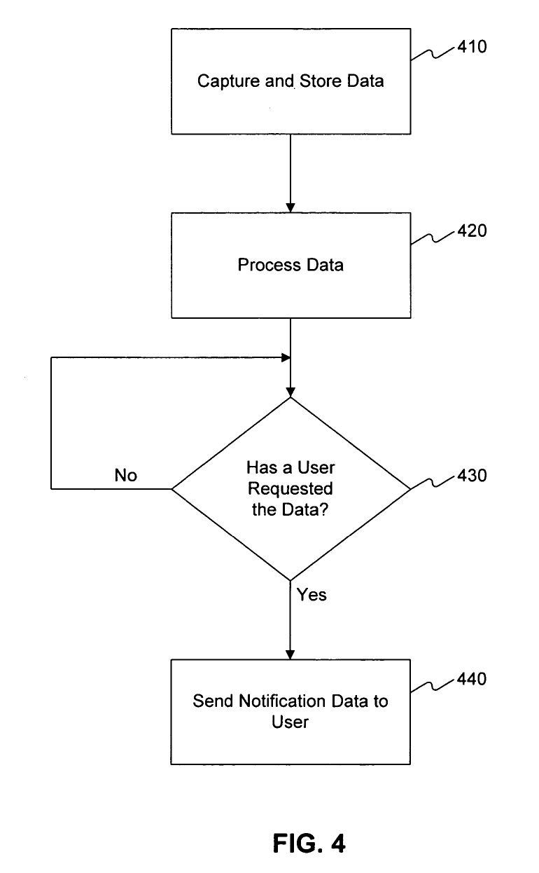

FIG. 4 illustrates a flowchart of exemplary steps associated with the Notify system operations, consistent with the present invention. Initially, the mail is processed and the Notify system captures and stores data received during the mail sorting process (step 410). For example, this data may include data captured through the scanning of codes, such as barcodes, located on the pieces of mail 101 or images of the pieces of mail 101. The data may then be processed and matched with the pertinent user based upon the delivery address (step 420). That is, based on the captured data, the destination of the mail may be determined. In addition, the data may also be processed based upon the level of subscription of the pertinent user.

Application server 140 will maintain the data until a request for the data is received from the user (step 430). Subsequently, if it has been determined that the user has requested the data, application server 160 electronically transmits the data to the user (step 440). As discussed above, the user may request the data in many different ways. For example, the user may request the data by accessing the user interface application 170 which may reside on the client device 160 or may be accessed by connecting to a Web site operated by the mail deliverer. In the former, the data may be downloaded automatically to the client device 160 on a periodic basis, at initiation of the user interface application, or upon a specific request from the user. Also, the user may be provided with the notification information through an e-mail system or whereby the e-mail system only provides a simple notification that a delivery has been made and the user may subsequently access more information about the delivery through the user interface application. Optionally, the user may receive telephone calls, such as through an interactive voice recognition (IVR) system, which may allow users to obtain information related to mail 101.

### Conclusion

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the Notify system may be applicable to any delivery system that may benefit from providing users at a remote location with information regarding the contents of a delivery or a delivery in route. Accordingly, the Notify system and method may be expanded beyond the use of notification for solely rental boxes.

Other exemplary uses of the present invention may involve extending the Notify service to offer images of mail to regular delivery users (i.e., users whose mail is delivered to the home or business site versus a rental box). This may involve the data capture of a full range of all mail or just a subset of the mail delivered to a user. As with rental box users, regular delivery users may select the type of mail that the deliverer takes images of and sends to the users via electronic means. Further, the Notify system may be to used notify a user that a certified mail piece is en route, or a piece of mail is coming from a bank or other sender that is significant to the user.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for providing a delivery notification of a delivery item to a user, comprising:
processing the delivery item;
capturing information data regarding the delivery item;
determining, based on the captured data, the destination of the delivery item;
receiving a request from the user for information related to the delivery item; and
electronically transmitting a notification to the user regarding information related to the delivery item.

2. The method of claim 1, wherein the delivery item comprises mail.

3. The method of claim 1, further comprising:
delivering the delivery item to a rental box.

4. The method of claim 1, wherein capturing information data comprises scanning code information located on the delivery item.

5. The method of claim 1, wherein capturing information data comprises capturing image data of the delivery item.

6. The method of claim 1, further comprising:
receiving from the user a selection of a level of notification service,
wherein electronically transmitting a notification comprises transmitting one of a plurality of levels of information detail corresponding to the level of notification selected by the user.

7. The method of claim 6, wherein transmitting the level of information comprises notification that the delivery item has been delivered.

8. The method of claim 6, wherein transmitting the level of information comprises information identifying the sender of the delivery item and the type of delivery item.

9. The method of claim 6, wherein transmitting the level of information comprises image data of the delivery item.

10. A method for providing a delivery notification to a delivery service user, comprising:
receiving an agreement from the user to participate in a notification process;
processing an item to be delivered;
capturing information data of the item during the processing;
delivering the item to a destination address; and
supplying the captured data to the user.

11. The method of claim 10, wherein capturing information comprises scanning code information located on the item.

12. The method of claim 10, wherein capturing information data comprises:
capturing image data of the item.

13. The method of claim 10, further comprising:
receiving from the user a selection of a level of notification service,
wherein electronically transmitting a notification comprises transmitting one of a plurality of levels of information detail corresponding to the level of notification selected by the user.

14. The method of claim 13, wherein transmitting the level of information comprises notification that the item have been delivered.

15. The method of claim 13, wherein transmitting the level of information comprises information identifying the sender of the item and the type of item.

16. The method of claim 13, wherein transmitting the level of information comprises image data of the item.

17. A system for providing to a user notification of a delivery item delivered to a rental delivery box, comprising:
delivery item processing equipment for sorting and processing the delivery item;
optical equipment associated with the processing equipment for capturing information regarding the delivery item;
a server to store the captured information; and
a user interface to supply the captured information to the user upon receipt of a user request.

18. The system of claim 17, wherein capturing information comprises scanning code information located on the delivery item.

19. The system of claim 17, wherein capturing information comprises capturing image data of the delivery item.

20. The system of claim 17, wherein the server receives and stores from the user a selection of a level of notification service, and wherein the user interface supplies one of a plurality of levels of information detail corresponding to the level of notification selected by the user.

21. The system of claim 20, wherein the level of information supplied comprises notification that the delivery item has been delivered.

22. The system of claim 20, wherein the level of information supplied comprises information identifying the sender of the delivery item and the type delivery item.

23. The system of claim 20, wherein the level of information supplied comprises image data of the delivery item.
